(19) United States
(12) Patent Application Publication
(10) Pub. No.: US 2017/0023831 A1
(43) Pub. Date: Jan. 26, 2017

(54) LCD DEVICE

(71) Applicant: SHENZHEN CHINA STAR OPTOELECTRONICS TECHNOLOGY CO. LTD., GUANGDONG (CN)

(72) Inventor: Xiangyang XU, Guangdong (CN)

(21) Appl. No.: 14/777,753

(22) PCT Filed: Aug. 7, 2015
(86) PCT No.: PCT/CN2015/086332

§ 371 Date: Sep. 17, 2015

(30) Foreign Application Priority Data
Jul. 24, 2015 (CN) 201510444215.7

(51) Int. Cl. G02F 1/1335

(52) U.S. Cl. CPC G02F 1/133621; G02F 1/13362; G02F 2203/05; G02F 2001/133614; G02F 2202/36; G02F 2203/07

(57) ABSTRACT

An LCD device is provided. The LCD device includes a blue backlight source, a lower polarizer, an array substrate, a liquid-crystal layer, an upper substrate, an upper polarizer, and a quantum excitation color filter layer. The LCD device is capable of emitting colored natural light by disposing the blue backlight source which has blue planar light with three wavelengths, improves luminous efficiency of the LCD device, and increases a viewing angle of the LCD device.

### TECHNICAL FIELD OF THE INVENTION

The present invention relates to a liquid crystal display (LCD) technology, and in particular to an LCD device.

### BACKGROUND OF THE INVENTION

A liquid-crystal display (LCD) technology has become a mainstream display technology. FIG. 1 is a schematic drawing illustrating a prior art LCD device, and FIG. 2 is a schematic drawing illustrating pixel structures of the prior art LCD device. 11 herein is a white backlight source, 12 is a lower polarizer, 13 is an array substrate, 14 is a liquid crystal layer, 15 is a color filter substrate, and 16 is an upper polarizer. In using the LCD device, liquid-crystal molecules within the liquid-crystal molecules 14 do not radiate, and the LCD device realizes the displaying function by the liquid-crystal molecules transmitting an outgoing light of the white backlight source 11 so luminous efficiency thereof is low. Meanwhile, in order to meet the need of displaying colored images, the array substrate 13 requires red pixel units R, green pixel units G, and blue pixel units B disposed thereon, and the outgoing light of these pixel units passes through corresponding color resists on the color filter substrate for realizing the display of multicolored patterns.

Meanwhile, due to optical properties of the liquid crystal, the LCD device needs to be equipped with the upper polarizer 16 and the lower polarizer 12 for working properly. This results in the outgoing light of the displayed images becoming a polarized light, not a natural outdoor light.

Moreover, a viewing angle of the displayed images that corresponds to the outgoing light modulated by the liquid-crystal molecules is generally less than 180 degrees, thereby being unable to achieve full-view display.

Therefore, there is a significant need to provide a LCD device for solving the problems existing in the prior art.

### SUMMARY OF THE INVENTION

An objective of the present invention is to provide a LCD device which is able to emit colored natural light with a higher luminous efficiency and a wider viewing angle, thereby solving the problems of being unable to emit colored natural light with a lower luminous efficiency and a narrower viewing angle.

An embodiment of the present invention provides an LCD device, which includes: a blue backlight source utilized to emit a blue planar light; a lower polarizer utilized to transform the blue planar light into a blue polarized light; an array substrate utilized to rotate liquid-crystal molecules in a liquid crystal layer; the liquid crystal layer utilized to modulate a part of the blue polarized light passing through the array substrate according to driving signals; an upper substrate utilized to form a space with the array substrate for keeping the liquid crystal layer; an upper polarizer utilized to obstruct the blue polarized light which is not modulated; and a quantum excitation color filter layer utilized to transform the blue polarized light which passes through the upper polarizer into a planar light comprising multicolored patterns; wherein the blue planar light comprises a first blue planar light with a first wavelength, a second blue planar light with a second wavelength, and a third blue planar light with a third wavelength; the lower polarizer is disposed on an exterior surface of the array substrate; the upper polarizer is disposed on an exterior surface of the upper substrate.

In the LCD device of the present invention, a first blue polarized light corresponding to the first blue planar light is transformed into a blue planar light by passing through the quantum excitation color filter layer.

In the LCD device of the present invention, a second blue polarized light corresponding to the second blue planar light is transformed into a green planar light by passing through the quantum excitation color filter layer.

In the LCD device of the present invention, a third blue polarized light corresponding to the third blue planar light is transformed into a red planar light by passing through the quantum excitation color filter layer.

In the LCD device of the present invention, each frame of the LCD device comprises a first sub-frame, a second sub-frame, and a third sub-frame.

The blue backlight source emits the first blue planar light during displaying the first sub-frame, emits the second blue planar light during displaying the second sub-frame, and emits the third blue planar light during displaying the third sub-frame.

In the LCD device of the present invention, the first sub-frame, the second sub-frame, and the third sub-frame are merged into the multicolored patterns of a current frame.

In the LCD device of the present invention, the first blue planar light is transformed into the first blue polarized light by passing through the lower polarizer, the second blue planar light is transformed into the second blue polarized light by passing through the lower polarizer, and the third blue planar light is transformed into the third blue polarized light by passing through the lower polarizer.

An embodiment of the present invention provides an LCD device, which includes: a blue backlight source utilized to emit a blue planar light; a lower polarizer utilized to transform the blue planar light into a blue polarized light; an array substrate utilized to rotate liquid-crystal molecules in a liquid crystal layer; the liquid crystal layer utilized to modulate a part of the blue polarized light passing through the array substrate according to driving signals; an upper substrate utilized to form a space with the array substrate for keeping the liquid crystal layer; an upper polarizer utilized to obstruct the blue polarized light which is not modulated; and a quantum excitation color filter layer utilized to transform the blue polarized light which passes through the upper polarizer into a planar light comprising multicolored patterns.

In the LCD device of the present invention, the blue planar light comprises a first blue planar light with a first wavelength, a second blue planar light with a second wavelength, and a third blue planar light with a third wavelength.

In the LCD device of the present invention, a first blue polarized light corresponding to the first blue planar light is transformed into a blue planar light by passing through the quantum excitation color filter layer.

In the LCD device of the present invention, a second blue polarized light corresponding to the second blue planar light is transformed into a green planar light by passing through the quantum excitation color filter layer.

In the LCD device of the present invention, a third blue polarized light corresponding to the third blue planar light is transformed into a red planar light by passing through the quantum excitation color filter layer.

In the LCD device of the present invention, each frame of the LCD device comprises a first sub-frame, a second sub-frame, and a third sub-frame; the blue backlight source emits the first blue planar light during displaying the first sub-frame, emits the second blue planar light during displaying the second sub-frame, and emits the third blue planar light during displaying the third sub-frame.

In the LCD device of the present invention, the first sub-frame, the second sub-frame, and the third sub-frame are merged into the multicolored patterns of a current frame.

In the LCD device of the present invention, the first blue planar light is transformed into the first blue polarized light by passing through the lower polarizer;

the second blue planar light is transformed into the second blue polarized light by passing through the lower polarizer; the third blue planar light is transformed into the third blue polarized light by passing through the lower polarizer.

In the LCD device of the present invention, the lower polarizer is disposed on an exterior surface of the array substrate.

In the LCD device of the present invention, the upper polarizer is disposed on an exterior surface of the upper substrate.

In comparison with the prior art LCD device, the LCD device of the present invention is capable of emitting the colored natural light by disposing the blue backlight source which has the blue planar light with three wavelengths, improves the luminous efficiency of the LCD device, and increases the viewing angle of the LCD device, so that the problems of being unable to emit colored natural light with a lower luminous efficiency and a narrower viewing angle are solved.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a schematic drawing illustrating a prior art LCD device;

FIG. 2 is a schematic drawing illustrating pixel structures of the prior art LCD device;

FIG. 3 is a schematic drawing illustrating an LCD device according to a preferred embodiment of the present invention;

FIG. 4 is a schematic drawing illustrating pixel structures of an LCD device according to a preferred embodiment of the present invention; and

FIG. 5 is a schematic drawing illustrating frames driven by the LCD device of the present invention.

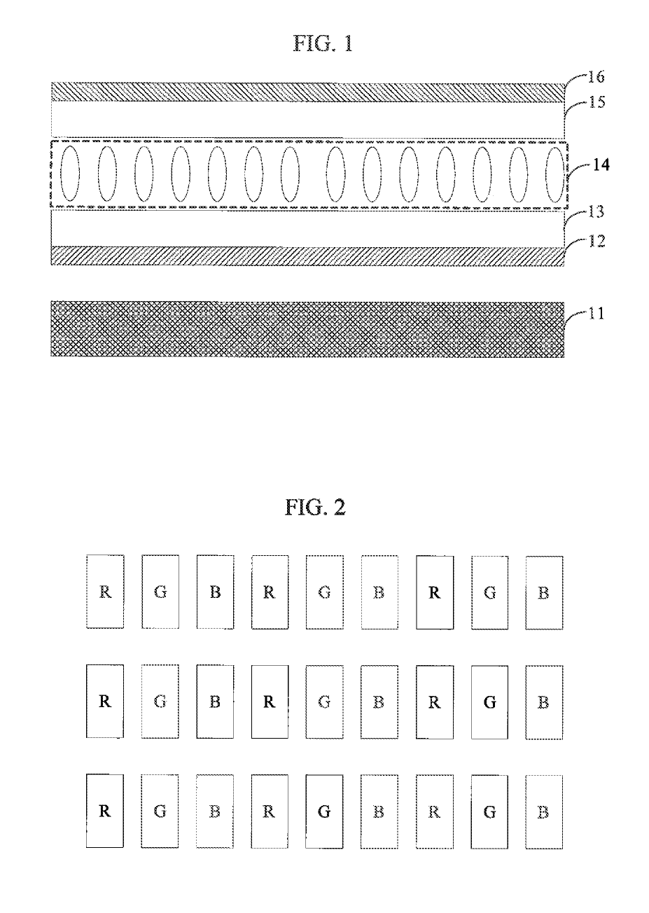

### DETAILED DESCRIPTION OF THE INVENTION

Descriptions of the following embodiments refer to attached drawings which are utilized to exemplify specific embodiments. Directional terms mentioned in the present invention, such as “top” and “down”, “front”, “rear”, “left”, “right”, “inside”, “outside”, “side” and so on are only directions with respect to the attached drawings. Therefore, the used directional terms are utilized to explain and understand the present invention but not to limit the present invention.

In different drawings, the same reference numerals refer to like parts throughout the drawings.

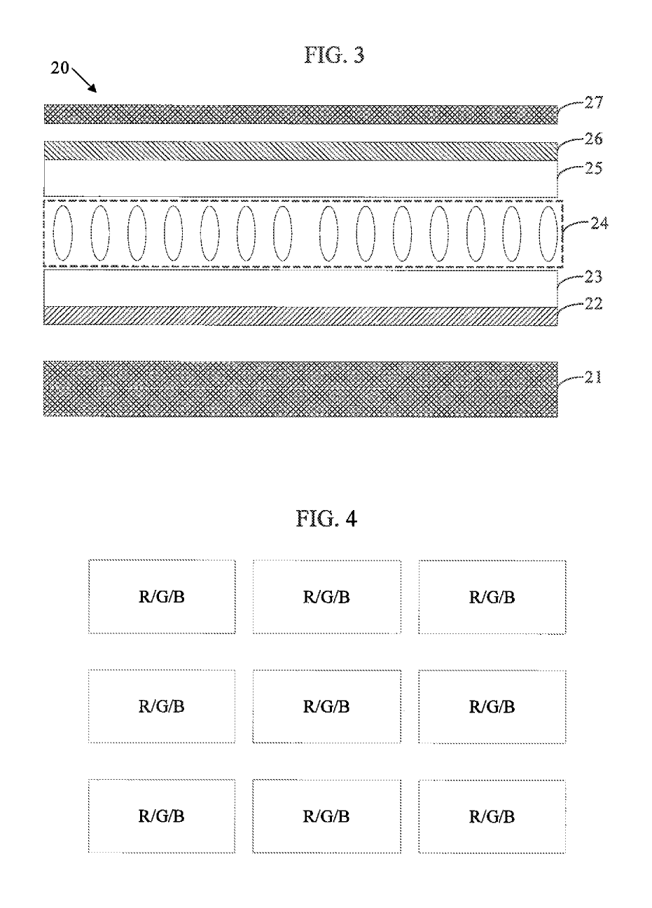

Referring to FIG. 3 and FIG. 4, FIG. 3 is a schematic drawing illustrating an LCD device according to a preferred embodiment of the present invention; FIG. 4 is a schematic drawing illustrating pixel structures of an LCD device according to a preferred embodiment of the present invention. The LCD device 20 of the preferred embodiment includes a blue backlight source 21, a lower polarizer 22, an array substrate 23, a liquid-crystal layer 24, an upper substrate 25, an upper polarizer 26, and a quantum excitation color filter layer 27. The blue backlight source 21 is utilized to emit a blue planar light; the lower polarizer 22 is utilized to transform the blue planar light into a blue polarized light; the array substrate 23 is utilized to rotate liquid-crystal molecules in a liquid-crystal layer; the liquid-crystal layer 24 is utilized to modulate a part of the blue polarized light passing through the array substrate 23 according to driving signals; the upper substrate 25 is utilized to form a space with the array substrate 23 for keeping the liquid-crystal layer 24; the upper polarizer 26 is utilized to obstruct the blue polarized light which is not modulated; the quantum excitation color filter layer 27 has quantum dot materials and is utilized to transform the blue polarized light which passes through the upper polarizer 26 into a planar light comprising multicolored patterns. The lower polarizer 22 herein is disposed on an exterior surface of the array substrate 23, and the upper polarizer 26 is disposed on an exterior surface of the upper substrate 25.

The blue planar light herein includes a first blue planar light with a first wavelength, a second blue planar light with a second wavelength, and a third blue planar light with a third wavelength.

The first blue planar light is transformed into the first blue polarized light by passing through the lower polarizer 26, and the first blue polarized light is transformed into the blue planar light through the quantum dot materials within the quantum excitation color filter layer 27 after passing through the array substrate 23, the liquid crystal layer 24, the upper substrate 25, and the upper polarizer 26.

The second blue planar light is transformed into the second blue polarized light by passing through the lower polarizer 26, and the second blue polarized light is transformed into the green planar light through the quantum dot materials within the quantum excitation color filter layer 27 after passing through the array substrate 23, the liquid crystal layer 24, the upper substrate 25, and the upper polarizer 26.

The third blue planar light is transformed into the third blue polarized light by passing through the lower polarizer 26, and the third blue polarized light is transformed into the red planar light through the quantum dot materials within the quantum excitation color filter layer 27 after passing through the array substrate 23, the liquid crystal layer 24, the upper substrate 25, and the upper polarizer 26.

Each frame of the LCD device 20 includes a first sub-frame, a second sub-frame, and a third sub-frame. The blue backlight source 21 emits the first blue planar light during displaying the first sub-frame, emits the second blue planar light during displaying the second sub-frame, and emits the third blue planar light during displaying the third sub-frame. Accordingly, the corresponding blue planar light of the first sub-frame, the corresponding green planar light of the second sub-frame, and the corresponding red planar light of the third sub-frame are merged into the multicolored patterns of the current frame.

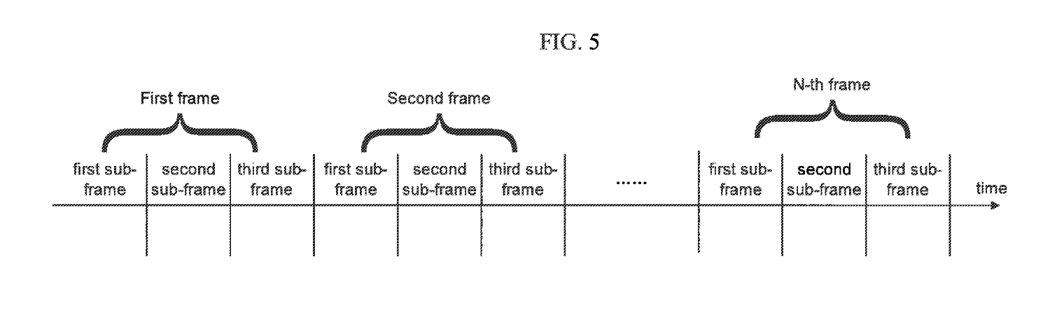

The operating principle of the LCD device of the preferred embodiment will now be described in detail with reference to FIG. 4 and FIG. 5. FIG. 4 is a schematic drawing illustrating pixel structures of an LCD device according to a preferred embodiment of the present invention; FIG. 5 is a schematic drawing illustrating frames driven by the LCD device of the present invention. Each frame of the LCD device is a combination of the superimposed first, second and third sub-frames.

In displaying the first sub-frame, the blue backlight source 21 emits the first blue planar light, and the first blue planar light is transformed into first blue polarized light by passing through the lower polarizer 22. The first blue polarized light is modulated by the liquid-crystal molecules within the liquid-crystal layer 24, and the modulated first blue polarized light enters the quantum excitation color filter layer 27 through the upper polarizer 25. The quantum dot materials in the quantum excitation color filter layer 27 transform the first blue planar light with the first wavelength into the blue planar light and then emit it.

In displaying the second sub-frame, the blue backlight source 21 emits the second blue planar light, and the second blue planar light is transformed into second blue polarized light by passing through the lower polarizer 22. The second blue polarized light is modulated by the liquid-crystal molecules within the liquid-crystal layer 24, and the modulated second blue polarized light enters the quantum excitation color filter layer 27 through the upper polarizer 25. The quantum dot materials in the quantum excitation color filter layer 27 transform the second blue planar light with the second wavelength into the green planar light and then emit it.

In displaying the third sub-frame, the blue backlight source 21 emits the third blue planar light, and the third blue planar light is transformed into third blue polarized light by passing through the lower polarizer 22. The third blue polarized light is modulated by the liquid-crystal molecules within the liquid-crystal layer 24, and the modulated third blue polarized light enters the quantum excitation color filter layer 27 through the upper polarizer 25. The quantum dot materials in the quantum excitation color filter layer 27 transform the third blue planar light with the third wavelength into the red planar light and then emit it.

Finally, the corresponding blue planar light of the first sub-frame, the corresponding green planar light of the second sub-frame, and the corresponding red planar light of the third sub-frame are merged into the multicolored patterns of the current frame.

Subsequently, the first sub-frame, second sub-frame, and third sub-frame of the next frame are displayed for forming the multicolored patterns of the next frame.

Meanwhile, since the blue planar light, green planar light and red planar light are excited by the blue planar light with different wavelengths, there is no need to dispose different color pixel units on the array substrate 23. As shown in FIG. 4, the array substrate 23 has the pixel units R/G/B, which is capable of displaying the blue planar light, green planar light and red planar light, disposed thereon, and there is no need to dispose color resists on the upper substrate 25. It only requires a corresponding increase in the refresh rate of the LCD device 20 to realize the display of multicolored patterns in the LCD device 20.

The blue backlight source 21 with a high emission efficiency is directly utilized to display images in the LCD device 20 of the preferred embodiment, thereby improving the luminous efficiency of the LCD device 20. Meanwhile, the LCD device 20 of the preferred embodiment can emit the planar light including multicolored patterns by the quantum excitation color filter layer 27, thereby increasing the viewing angle of the LCD device 20.

The LCD device of the present invention is capable of emitting the colored natural light by disposing the blue backlight source which has the blue planar light with three wavelengths, improves the luminous efficiency of the LCD device, and increases the viewing angle of the LCD device, so that the problems of being unable to emit colored natural light with a lower luminous efficiency and a narrower viewing angle are solved.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A liquid crystal display (LCD) device, comprising:
a blue backlight source utilized to emit a blue planar light;
a lower polarizer utilized to transform the blue planar light into a blue polarized light;
an array substrate utilized to rotate liquid-crystal molecules in a liquid crystal layer;
the liquid crystal layer utilized to modulate a part of the blue polarized light passing through the array substrate according to driving signals;
an upper substrate utilized to form a space with the array substrate for keeping the liquid crystal layer;
an upper polarizer utilized to obstruct the blue polarized light which is not modulated; and
a quantum excitation color filter layer utilized to transform the blue polarized light which passes through the upper polarizer into a planar light comprising multicolored patterns;
wherein the blue planar light comprises a first blue planar light with a first wavelength, a second blue planar light with a second wavelength, and a third blue planar light with a third wavelength; the lower polarizer is disposed on an exterior surface of the array substrate; the upper polarizer is disposed on an exterior surface of the upper substrate.

2. The LCD device according to claim 1, wherein a first blue polarized light corresponding to the first blue planar light is transformed into a blue planar light by passing through the quantum excitation color filter layer.

3. The LCD device according to claim 2, wherein a second blue polarized light corresponding to the second blue planar light is transformed into a green planar light by passing through the quantum excitation color filter layer.

4. The LCD device according to claim 3, wherein a third blue polarized light corresponding to the third blue planar light is transformed into a red planar light by passing through the quantum excitation color filter layer.

5. The LCD device according to claim 1, wherein each frame of the LCD device comprises a first sub-frame, a second sub-frame, and a third sub-frame;
the blue backlight source emits the first blue planar light during displaying the first sub-frame, emits the second blue planar light during displaying the second sub-frame, and emits the third blue planar light during displaying the third sub-frame.

6. The LCD device according to claim 5, wherein the first sub-frame, the second sub-frame, and the third sub-frame are merged into the multicolored patterns of a current frame.

7. The LCD device according to claim 5, wherein the first blue planar light is transformed into the first blue polarized light by passing through the lower polarizer, the second blue planar light is transformed into the second blue polarized light by passing through the lower polarizer, and the third blue planar light is transformed into the third blue polarized light by passing through the lower polarizer.

8. A liquid crystal display (LCD) device, comprising:
a blue backlight source utilized to emit a blue planar light;
a lower polarizer utilized to transform the blue planar light into a blue polarized light;
an array substrate utilized to rotate liquid-crystal molecules in a liquid crystal layer;
the liquid crystal layer utilized to modulate a part of the blue polarized light passing through the array substrate according to driving signals;
an upper substrate utilized to form a space with the array substrate for keeping the liquid crystal layer;
an upper polarizer utilized to obstruct the blue polarized light which is not modulated; and
a quantum excitation color filter layer utilized to transform the blue polarized light which passes through the upper polarizer into a planar light comprising multicolored patterns.

9. The LCD device according to claim 8, wherein the blue planar light comprises a first blue planar light with a first wavelength, a second blue planar light with a second wavelength, and a third blue planar light with a third wavelength.

10. The LCD device according to claim 9, wherein a first blue polarized light corresponding to the first blue planar light is transformed into a blue planar light by passing through the quantum excitation color filter layer.

11. The LCD device according to claim 10, wherein a second blue polarized light corresponding to the second blue planar light is transformed into a green planar light by passing through the quantum excitation color filter layer.

12. The LCD device according to claim 11, wherein a third blue polarized light corresponding to the third blue planar light is transformed into a red planar light by passing through the quantum excitation color filter layer.

13. The LCD device according to claim 9, wherein each frame of the LCD device comprises a first sub-frame, a second sub-frame, and a third sub-frame;
the blue backlight source emits the first blue planar light during displaying the first sub-frame, emits the second blue planar light during displaying the second sub-frame, and emits the third blue planar light during displaying the third sub-frame.

14. The LCD device according to claim 13, wherein the first sub-frame, the second sub-frame, and the third sub-frame are merged into the multicolored patterns of a current frame.

15. The LCD device according to claim 13, wherein the first blue planar light is transformed into the first blue polarized light by passing through the lower polarizer, the second blue planar light is transformed into the second blue polarized light by passing through the lower polarizer, and the third blue planar light is transformed into the third blue polarized light by passing through the lower polarizer.

16. The LCD device according to claim 8, wherein the lower polarizer is disposed on an exterior surface of the array substrate.

17. The LCD device according to claim 8, wherein the upper polarizer is disposed on an exterior surface of the upper substrate.
